(19) United States
(12) Patent Application Publication
(10) Pub. No.: US 2004/0260572 A1
(43) Pub. Date: Dec. 23, 2004

(54) Digital photofinishing system and method offering operator-defined packages of prints

(76) Inventors: Kevin George, Pequannock, NJ (US); Brian Ilchert, Waldwick, NJ (US); Kohei Sakura, Atsugi (JP)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/784,545

(22) Filed: Feb. 23, 2004

Related U.S. Application Data
(60) Provisional application No. 60/449,423, filed on Feb. 21, 2003.

(51) Int. Cl. G06F 17/60

(52) U.S. Cl. 705/1

(57) ABSTRACT

A method and apparatus is provided for processing at least one digital image to provide a photofinishing product to a user. The method begins by receiving at least one digital image located on a physical medium provided by the user. Responsive to a user request, at least one operator-definable package of photofinishing products is offered to the user. An input is received, which specifies at least one package selected by the user. A photofinishing product is then provided to the user in accordance with the specified package.

### STATEMENT OF RELATED APPLICATIONS

This application claims the benefit of priority to U.S. provisional patent application 60/449,423, filed Feb. 21, 2003, and entitled “Photofinishing Print Station-Package Prints.”

### FIELD OF THE INVENTION

The present invention relates generally to digital imaging, and more particularly to a digital photofinishing system for rendering a digital image stored on a physical medium.

### BACKGROUND OF THE INVENTION

Digital photofinishing systems are beginning to supplement optical printing labs in the commercial trade, in part to provide printing services to digital still cameras as well as network services to current cameras designed for optical printing. Most consumers today use digital photofinishing systems such as photo kiosks and digital minilabs for making reprints or enlargements from their existing pictures without negatives. Consumers also want to digitize their existing pictures and keep them on a CD or other storage medium. Moreover, as the population of digital camera owners increases, the demand for digital imaging services is growing rapidly. Digital photofinishing systems allow digital camera users to obtain immediate prints.

Many digital photofinishing systems can be directly operated by the customer. Customers can generally preview their pictures on a screen and select the ones they want to print out by using inputs such as graphical user interfaces (GUIs) located on a touch screen. Customers can also enhance the images in a variety of ways prior to printing. For example, the brightness, contrast and color of the images can generally be controlled by the customer. Likewise, the images can be retouched such as by cropping, zooming, rotating and removing redeye. The customer can also add things to the printed image such as a date stamp or text.

The customer typically begins the photofinishing process by selecting via, e.g., the touch screen, the print size that is desired. The customer will usually select from a predefined selection of print sizes such as wallet, 4×6, 5×7, and 8×10. The customer then inserts the medium on which the digital images are located and the photofinishing system automatically reads the data from the medium and generates on-screen thumbnail pictures. The customer chooses the pictures to print by touching (in the case of a touch screen) or clicking on (in the case of mouse) the desired image or images. A range of enhancements are then presented to the customer for each image. Each enhancement that is selected is previewed on-screen prior to printing. After the printing process is completed, a receipt is printed and the system operator (e.g., the retailer) collects the payment. Alternatively, the digital photofinishing system may incorporate a credit card reader, in which case the customer inserts a credit card prior to initiating the process.

Customers often desire to print out a picture in multiple copies and in multiple sizes. In the aforementioned digital photofinishing system the consumer may be required to select and print each size individually from one another, which can be a relatively time consuming process. Moreover, consumers may expect to be presented with the option of selecting from different combinations of sizes and quantities of prints, which are made available in different packages at prices that are typically lower than they would be if each print were purchased individually.

Accordingly, it would be desirable to provide a digital photofinishing system that can offer various package combinations of prints and prices that are configurable by the system operator.

### SUMMARY OF THE INVENTION

In accordance with the present invention, a method and apparatus is provided for processing at least one digital image to provide a photofinishing product to a user. The method begins by receiving at least one digital image located on a physical medium provided by the user. Responsive to a user request, at least one operator-definable package of photofinishing products is offered to the user. An input is received, which specifies at least one package selected by the user. A photofinishing product is then provided to the user in accordance with the specified package.

In accordance with one aspect of the present invention, the package of photofinishing products includes a photographic print of the digital image provided in predetermined quantities and at least one predetermined size.

In accordance with another aspect of the present invention, the package includes a photographic print of the digital image provided in predetermined quantities for each of a plurality of predetermined sizes.

In accordance with another aspect of the present invention, the package of photofinishing products further includes a price for the package.

In accordance with another aspect of the present invention, the package of photofinishing products further includes a second physical medium onto which the digital image is transferred.

In accordance with another aspect of the present invention, the second physical medium is a CD-ROM.

In accordance with another aspect of the present invention, the step of receiving at least one digital image includes the step of receiving a plurality of digital images located on the physical medium and further comprises the step of receiving from the user a second input identifying at least one of the digital images to be embodied in the photofinishing product.

In accordance with another aspect of the present invention, the digital images are displayed prior to receiving the second input from the user.

In accordance with another aspect of the present invention, an input is received from the user specifying at least one enhancement to the digital image.

In accordance with another aspect of the present invention, the enhancement is selected from the group consisting of brightness, contrast and retouching.

In accordance with another aspect of the present invention, an input is received from the operator defining the predetermined quantities and the predetermined size of the package.

In accordance with another aspect of the present invention, the input is received at least in part via a touch screen display.

In accordance with another aspect of the present invention, the input is received at least in part via a keyboard.

In accordance with another aspect of the present invention, the input is received over a communications network.

In accordance with another aspect of the present invention, the offering step is performed via a graphical user interface displayed on a monitor.

In accordance with another aspect of the present invention, at least one photographic image is scanned to produce the digital image.

In accordance with another aspect of the present invention, a digital photofinishing system provided. The system includes a digital image reader for receiving a physical medium on which at least one digital image is located and a digital image processor for producing an output image from the digital image located on the physical medium. An image output device is provided for embodying the output image in an output medium. A monitor displays the output image and offers to a user at least one operator-definable package of photofinishing products. A controller is operatively associated with the digital image reader, the digital image processor, the image output device and the monitor. An operator interface is operatively associated with the controller for selectively defining at least one package of photofinishing products to be offered to the user.

### BRIEF DESCRIPTION OF THE DRAWINGS

FIG. 1 shows a digital photofinishing system constructed in accordance with the present invention.

FIG. 2 shows an exemplary digital image processor that can be employed in the present invention.

FIG. 3 shows one embodiment of an administrative setup menu in accordance with the present invention.

FIG. 4 is a flowchart showing an exemplary sequence of steps performed by both the system operator and the user in connection with the digital photofinishing system shown in FIG. 1.

### DETAILED DESCRIPTION

The present invention relates to a digital photofinishing system that provides a means by which the system operator can customize the print packages and prices that are offered to the customer. The invention allows the system operator, who may be a retailer having an establishment in which the digital photofinishing system is located, to easily and flexibly set up multiple package options via an administrative setup program. By allowing the system operator to choose the quantity, type and pricing of the various packages that are offered, the sales volume and revenue potentially can be enhanced by quite a significant amount.

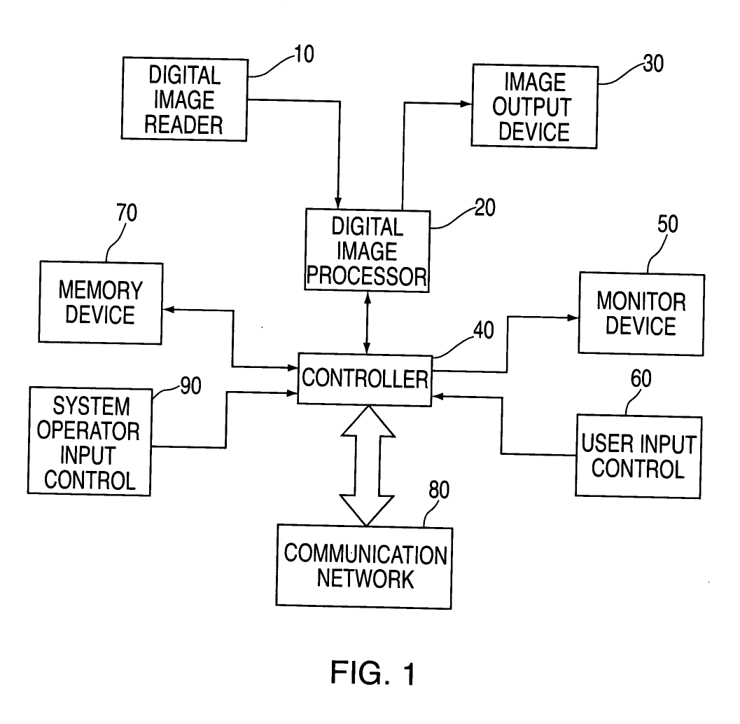

The digital photofinishing system shown in FIG. 1 includes one or more digital image readers 10, a digital image processor 20, and one or more multiple image output devices 30 such as a digital printer. The digital photofinishing system also includes a controller 40 such as a general control computer. A monitor device 50 and a user input control 60 serve as output and input devices, respectively, to the controller 40. The user input 60 may be, for example, a keyboard and mouse, a touch screen incorporated into monitor device 50, or a combination of both a keyboard and touch screen. As explained in more detail below, a system operator input control 90 allows the system operator to access an administrative setup menu through which the packages are selected.

Depending on the manner in which the user is to interact with the system, the digital photofinishing system of the present invention can be incorporated into a kiosk system, a microlab system, a minilab system, or a high productivity wholesale finishing system. As discussed below, regardless of the form that the digital photofinishing system takes, in some embodiments of the invention the user may also interact with it from a remote location over a computer network such as Internet, for example. Likewise, the

The digital image reader 10 can accept one or more types of digital recording media, including, but not limited to, a CD-ROM, PC card, Memory Stick®, Compact Flash card, mini CD-ROM, Secure Digital card, floppy disk or a Smart Media™ card. In some cases the digital photofinishing system may include two or more digital image readers that each read a different type of digital medium. One of the digital image readers may also be a photographic film transparency scanner for generating a digital image from a photographic film transparency. The digital image reader 10 may also include an adapter that can accept digital recording media that are not yet available.

Digital image processors of the type employed in the present invention are generally known, However, an exemplary processor will be described below for illustrative purposes only and not as a limitation on the invention. The digital image processor 20 provides the means for processing the digital images to produce enhanced digital images. These enhanced digital images are received by an image output device 30 such as a digital printer that produces photographic prints. The digital image processor 20 processes an input digital image to produce an output digital image that has been enhanced in some manner and prepared for the output device 30. The general control computer 40 receives information from, and transmits information to, the digital image processor 20 that affects the manner in which digital images are processed. An offline memory device 70 is also connected to the general control computer 40 and can be used for the purposes of storing and receiving information. The monitor device 50 is connected to the general control computer 40, and allows both the customer and the system operator (e.g., a retailer) to monitor the system activity, either directly on-site or from a remote location over a wired or wireless connection.

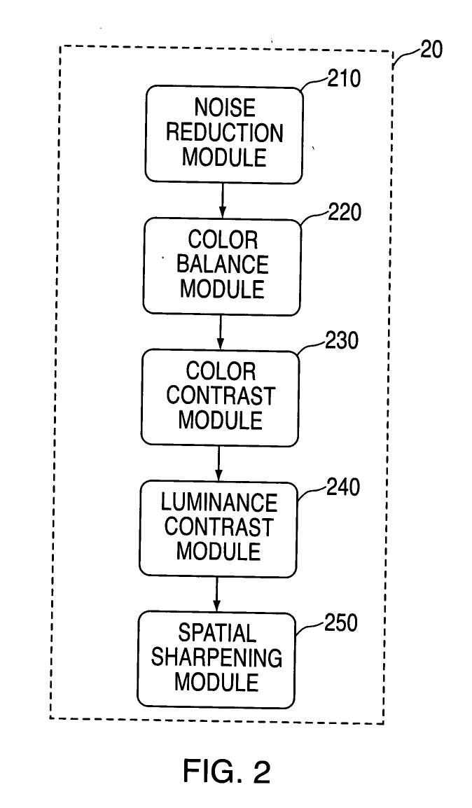

The exemplary digital image processor 20 includes a variety of image processing modules that can customize the image quality of the resultant photographic prints produced. For example, as shown in FIG. 2, in some embodiments of the invention the digital image processor 20 may include a noise reduction module 210, a color balance module 220, a color contrast module 230, a luminance contrast module 240, and a spatial sharpening module 250. Each image processing module receives a digital image, modifies the pixel values of the image, and passes the modified digital image to the next image processing module in the sequence. While the image processing modules shown in FIG. 2 have a specific sequential order, it is possible to use the same image processing modules in a different sequential order and still achieve good results.

The noise reduction module 210 may use any of a variety of algorithms such as the Sigma filter described in Digital Image Smoothing and the Sigma Filter, Computer Vision, Graphics, and Image Processing Vol. 24, p. 255-269, 1983. The color balance module 220 has the effect of imparting an overall color cast to digital images. The input digital images to the color balance module 220 are in a red, green, and blue representation, i.e., they include a red, green, and blue digital image channel. The color balance module 220 converts the input digital image into a luminance-chrominance representation wherein a matrix is applied to the red, green, and blue pixel data resulting in three digital image channels, a luminance digital image channel (L), a green-magenta (GM) digital image channel, and an illuminant (ILL) digital image channel. The color contrast module 230 receives the processed digital image from the color balance module 220. The color contrast module 230 modifies the pixel values of the luminance-chrominance representation by multiplying the green-magenta and illuminant digital image channel pixel values by a processing control parameter. The use of varying values for the processing control parameter allow the user to print images with either increased color contrast (corresponding to higher values for the processing control parameter) or with a more subtle rendition (corresponding to lower values for the processing control parameter). The luminance contrast module 240 receives the processed digital image from the color contrast module 230. The luminance contrast module 240 modifies the pixel values of the luminance-chrominance representation by multiplying the luminance digital image channel pixel values by a luminance contrast processing control parameter. The spatial sharpening module 250 receives the processed digital image from the luminance contrast module 240 and uses a form of unsharp masking to achieve a range of spatial sharpening effects. The optimum system default value for the parameter employed by the spatial sharpening module 240 is generally application specific and, in particular, depends on the spatial imaging characteristics of the digital printer used.

From a user perspective, optimum values for the aforementioned processing control parameters depends on such things as the physical sizes of the prints, the source of the digital images, and the like.

In accordance with the present invention, the system operator enters an administrative setup mode using the system operator input control 90. It should be noted that the system operator input control 90 and the user input control 60 are not necessarily discrete elements as depicted in FIG. 1. For example, if the user input control 60 is a keyboard, the system operator may enter the administrative setup mode with the use of a special sequence of keys. Alternatively, if the user input control 60 is a touch screen located on monitor device 50, the administrative setup mode may be entered by the appropriate selection of on-screen icons. Of course, in some embodiments of the invention user input control 60 and system operator control 90 may in fact be different components.

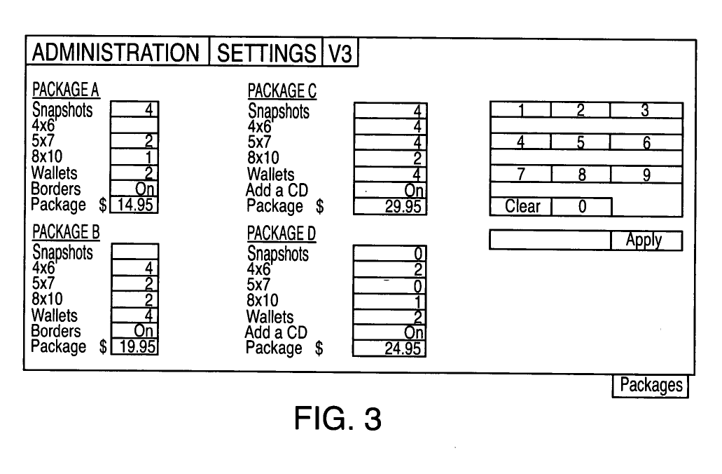

When the system operator enters the setup mode an administrative setup menu is displayed on monitor device 50. An example of such a menu is shown in FIG. 3. As shown, the setup menu presents the system operator with a number of different packages (e.g., packages A-D in this example). For each package the user enters the number of prints to be provided in each of a variety of predetermined sizes. For example, the system operator has specified that package A in FIG. 3 should include 4 snapshots, 2 5×7 prints, 1 8×10 print, and 2 wallet size prints. All of the prints are also specified to have borders and the price for the package is $14.95. The system operator completes packages B-D in a similar manner. Other packages may also be offered for large numbers of prints at volume discounts.

The operating program associated with the administrative setup mode may be executed by general control computer 40 and stored in offline memory device 70. Of course, the operating program may be embodied in hardware, software, firmware, or any combination thereof.

In some embodiments of the invention the system operator may enter the administrative setup mode remotely via a communications network 80 (e.g., the Internet) that interfaces with the general control computer 40. Communications network 80 may also be used to provide interactive customer services so that the user can process orders from a remote location through a personal computer, mobile computer, PDA, or even a dedicated kiosk that is remotely located from the digital photofinishing system.

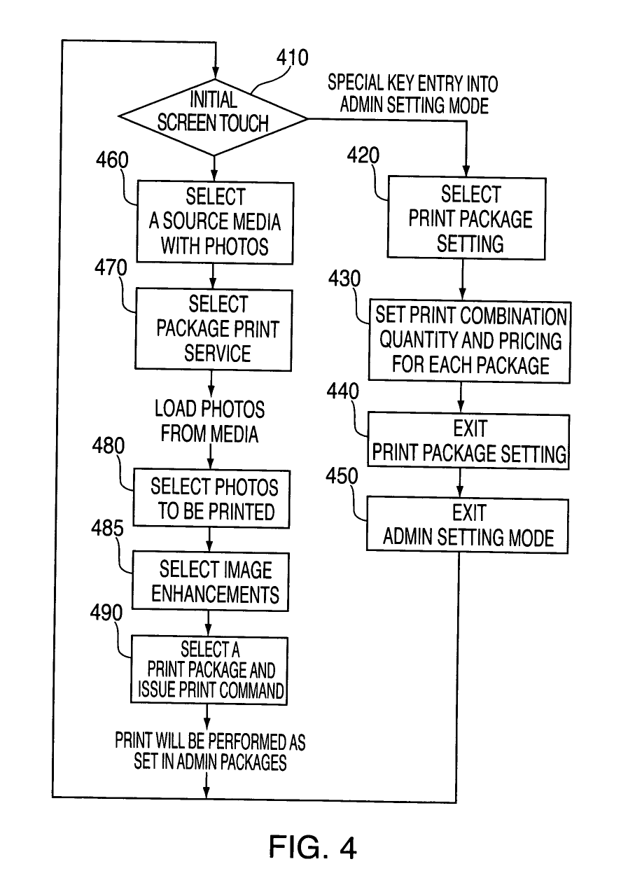

FIG. 4 is a flowchart showing an exemplary sequence of steps performed by both the system operator and the user in connection with the digital photofinishing system shown in FIG. 1. When the system operator desires to offer one or more print packages, either when the system is initially installed or at a later time, the administrative setup mode is entered via system operator input control 90 (step 410). Next, the system operator selects the print package menu (step 420) and then uses the menu to select the various combinations of print sizes, quantities, and pricing for each of the packages to be offered (step 430). When complete, the system operator exits the print package menu (step 440) and the administrative setup mode (step 450).

When a user desires to make one or more prints from a recording medium on which the digital images are located, the user first enters the photofinishing processing mode via input control 60 (step 410) and inserts the medium into the photofinishing system (step 460). The user is then presented with a menu on the monitor device 50 showing the services that are available, including the availability of any packages. Using input control 60, the user makes a selection from this menu to access the available package options (step 470) and selects the images that are printed (step 480). The images are selected from thumbnails that are generated by the digital image processor 20 and displayed on the monitor device 50. The user then performs any enhancements to the images that are to be printed (step 485), which are previewed on monitor device 50. Finally, the user confirms selection of the desired print package and issues the print command (step 490) or selects an additional print package prior to issuing the print command. While the steps shown in FIG. 4 are depicted in a particular sequential order, those of ordinary skill in the art will recognize that many of the steps may be performed in different sequences. For example, the images to be printed (step 480) may be selected before using the available package options (step 470).

1. A method for processing at least one digital image to provide a photofinishing product to a user, comprising:
receiving at least one digital image located on a physical medium provided by the user;
responsive to a user request, offering to the user at least one operator-definable package of photofinishing products;
receiving an input specifying at least one package selected by the user; and
providing a photofinishing product to the user in accordance with the specified package.

2. The method of claim 1 wherein the package of photofinishing products includes a photographic print of the digital image provided in predetermined quantities and at least one predetermined size.

3. The method of claim 1 wherein the package of photofinishing products includes a photographic print of the digital image provided in predetermined quantities for each of a plurality of predetermined sizes.

4. The method of claim 2 wherein the package of photofinishing products further includes a price for said package.

5. The method of claim 2 wherein the package of photofinishing products further includes a second physical medium onto which the digital image is transferred.

6. The method of claim 1 wherein said photofinishing product is a second physical medium onto which the digital image is transferred.

7. The method of claim 5 wherein said second physical medium is a CD-ROM.

8. The method of claim 1 wherein the step of receiving at least one digital image includes the step of receiving a plurality of digital images located on the physical medium and further comprising the step of receiving from the user a second input identifying at least one of the digital images to be embodied in the photofinishing product.

9. The method of claim 8 further comprising the step of displaying the digital images prior to the step of receiving the second input from the user.

10. The method of claim 1 further comprising the step of receiving an input from the user specifying at least one enhancement to the digital image.

11. The method of claim 10 wherein said enhancement is selected from the group consisting of brightness, contrast and retouching.

12. The method of claim 1 further comprising the step of receiving from the operator an input defining the predetermined quantities and the predetermined size of the package.

13. The method of claim 1 wherein said input is received at least in part via a touch screen display.

14. The method of claim 1 wherein said input is received at least in part via a keyboard.

15. The method of claim 1 wherein said input is received over a communications network.

16. The method of claim 12 wherein said inputs are received at least in part via a touch screen display.

17. The method of claim 12 wherein said inputs are received at least in part via a keyboard.

18. The method of claim 12 wherein said inputs are received over a communications network.

19. The method of claim 1 wherein the offering step is performed via a graphical user interface displayed on a monitor.

20. The method of claim 1 further comprising the step of scanning at least one photographic image to produce said at least one digital image.

21. A digital photofinishing system, comprising:
a digital image reader for receiving a physical medium on which at least one digital image is located;
a digital image processor for producing an output image from the digital image located on the physical medium;
an image output device for embodying the output image in an output medium;
a monitor for displaying the output image and offering to a user at least one operator-definable package of photofinishing products;
a controller operatively associated with the digital image reader, the digital image processor, the image output device and the monitor; and
an operator interface operatively associated with the controller for selectively defining at least one package of photofinishing products to be offered to the user.

22. The digital photofinishing system of claim 21 wherein the package of photofinishing products includes a photographic print of the digital image provided in predetermined quantities and at least one predetermined size.

23. The digital photofinishing system of claim 21 wherein the package of photofinishing products includes a photographic print of the digital image provided in predetermined quantities for each of a plurality of predetermined sizes.

24. The digital photofinishing system of claim 22 wherein the package of photofinishing products further includes a price for said package.

25. The digital photofinishing system of claim 22 wherein the package of photofinishing products further includes a second physical medium onto which the digital image is transferred.

26. The digital photofinishing system of claim 21 wherein said photofinishing product is a second physical medium onto which the digital image is transferred.

27. The digital photofinishing system of claim 25 wherein said second physical medium is a CD-ROM.

28. The digital photofinishing system of claim 21 wherein said image output device comprises a printer.

29. The digital photofinishing system of claim 21 further comprising a user interface for receiving an input from the user specifying at least one enhancement to the digital image.

30. The digital photofinishing system of claim 29 wherein said enhancement is selected from the group consisting of brightness, contrast and retouching.

31. The digital photofinishing system of claim 21 wherein said operator interface further serves as a user interface for receiving an input from the user specifying at least one enhancement to the digital image.

32. The digital photofinishing system of claim 21 wherein said operator interface comprises a touch screen display.

33. The digital photofinishing system of claim 21 wherein said operator interface comprises a keyboard.

34. The digital photofinishing system of claim 29 wherein said user interface and said operator interface comprise a common touch screen display.

35. The digital photofinishing system of claim 29 wherein said user interface and said operator interface comprise a common keyboard.

36. The digital photofinishing system of claim 21 further comprising a scanner for scanning a photographic image to produce a digital image to be processed by the digital image processor.
